(19) United States
(12) Patent Application Publication
(10) Pub. No.: US 2003/0070887 A1
(43) Pub. Date: Apr. 17, 2003

(54) Brake caliper comprising at least two opposite pistons

(76) Inventor: Gilbert Beringer, Chatelneuf (FR)

Correspondence Address: HESLIN ROTHENBERG FARLEY & MESITI PC, 5 COLUMBIA CIRCLE, ALBANY, NY, 12203, US

(21) Appl. No.: 10/264,349

(22) Filed: Oct. 3, 2002

(30) Foreign Application Priority Data
Apr. 3, 2000 (FR) 00.04531

(51) Int. Cl. F16D 55/14

(52) U.S. Cl. 188/72.2

(57) ABSTRACT

The invention concerns a brake caliper comprising at least two opposite pistons (4 and 5) mounted in a housing (1-2) with fittings for mounting, in two parallel planes, two friction pads (7) and (8) secured to said pistons to act at least on a disc (9). The invention is characterized in that the fittings for mounting the friction pads (7 and 8) consist of means (10 and 11) adapted to pick up the tangent effort of said fiction pads so as to avoid any movement of the latter during braking; the means (10 and 11) adapted to pick up the tangent effort of the fiction pads (7 and 8) are arranged in one or more zones of the housing (1-2) where there is no deformation.

The invention relates to the technical field of braking devices for all types of vehicles, such as motor cars, motorcycles, airplanes, and relates more particularly to brake calipers.

Brake calipers are one of the important parts of a braking device. Essentially, in a known way, a brake caliper comprises pistons mounted in a casing exhibiting arrangements for mounting, in two parallel planes, two pads paired with the pistons so as to act on at least one disk exhibited by the wheel of the vehicle in question. The pistons are connected hydraulically to a master cylinder to be operated by one or more actuating members that can be operated by hand or by foot depending on the type of vehicle concerned.

More specifically, the invention relates to a brake caliper comprising at least two opposed pistons mounted in a casing of one-piece type or made in two parts.

The purpose of the braking action is to cause the vehicle to decelerate, possibly followed by bringing this vehicle to a complete standstill. This braking action is essentially defined by the pressure sent to the brake caliper by the master cylinder. This results in a reaction which corresponds to the amount of deceleration that can be felt in various ways by the driver. In fact, the amount of deceleration is very difficult to assess.

For example, this amount of deceleration may be perceived directly by a feeling of the phenomenon of horizontal acceleration in the user's body (particularly in the case of a motorbike), or directly by taking in the reduction of speed perceived by the passing of the landscape. This amount of deceleration may also be perceived indirectly by assessing the variation in trim of vehicles resulting from the horizontal component of the acceleration, the vehicle having a tendency to dive down to the front. This reaction is most used for metering the braking action, but is strewn with errors. What happens is that, for the same amount of deceleration, the extent to which the vehicle dives varies according to how laden it is, to how the suspension is set up, and to other phenomena.

In order to obtain the desired deceleration, the driver acts on the braking member causing his vehicle to react. Depending on this reaction, the driver is forced several times to modify the action he is exerting on the braking member in order to obtain the desired deceleration. The result obtained is therefore not immediate. This response time is therefore likely to cause many meters to be lost over a stopping distance.

When the driver is sufficiently experienced, provided he knows his vehicle well, he may, by learning, determine the precise force that he needs to apply to the actuating member in order to obtain the desired deceleration. In this case, the result is instant but the chain of command needs to be reliable. Otherwise, the result will not be the one the driver hoped for.

The driver is therefore forced to learn how to use his braking system or to determine experimentally the travel and force needed on the braking actuating member, so as to obtain the desired deceleration. This learning takes place naturally and unconsciously. The precision with which the braking action can be learnt and metered is governed by the faithfulness of the system. The ideal is to have a practically linear link between the hydraulic pressure in the brake circuit and the deceleration.

Significant technical progress has been made in the field of braking. Thus, the switch from cable control to hydraulic control, then from drum brakes to disk brakes, has allowed the reliability of the braking to be increased. The power and endurance of brakes have been improved. Likewise, numerous brake-boosting systems have emerged, particularly for avoiding any untimely locking of the wheels. However, no particular effort has been made to improve the faithfulness of the system. On the contrary, the more widespread use of boosted brakes has degraded the reliability by introducing a response time to the variation in force of the actuating member for the same deceleration.

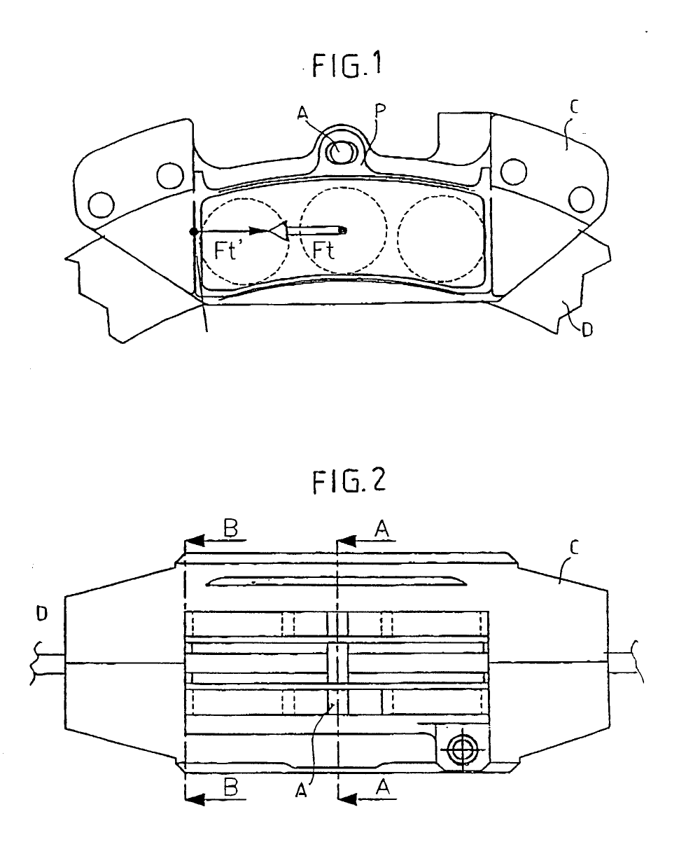

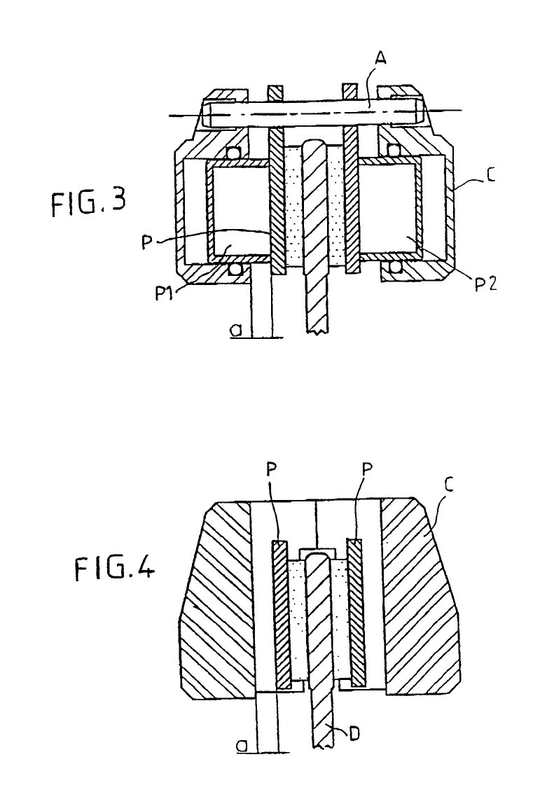

In a conventional caliper with opposed pistons, the force tangential to the pads is reacted by the caliper casing, which may or may not be protected by pads attached to said casing. Reference is made to FIGS. 1 and 2 of the drawings which show, respectively, in a view from the front and in a view from above, one embodiment of a brake caliper according to the prior art. The pads (P) are mounted on each side of the disk (D) and supported, on the upper part, by a transverse pin (A) situated very roughly in the central part and engaged in arrangements in the caliper casing. The opposed pistons (P1) and (P2) paired with the pads, are mounted in corresponding housings of the casing. Reference is made more particularly to FIG. 3 of the drawings.

If the caliper is considered as a whole in a transverse plane, the pads are a distance (a) from the corresponding internal face of the casing.

Reference is made to FIGS. 3 and 4 which show the caliper, in two different sections, and considered at rest, that is to say when no pressure force is exerted on the braking member. By contrast, under the effect of the pressure exerted, the casing of the caliper has a tendency to open up to a not insignificant extent in this zone (0.2-0.5 mm) creating friction between the pad and the casing, and this has the effect of countering the normal force of the pistons.

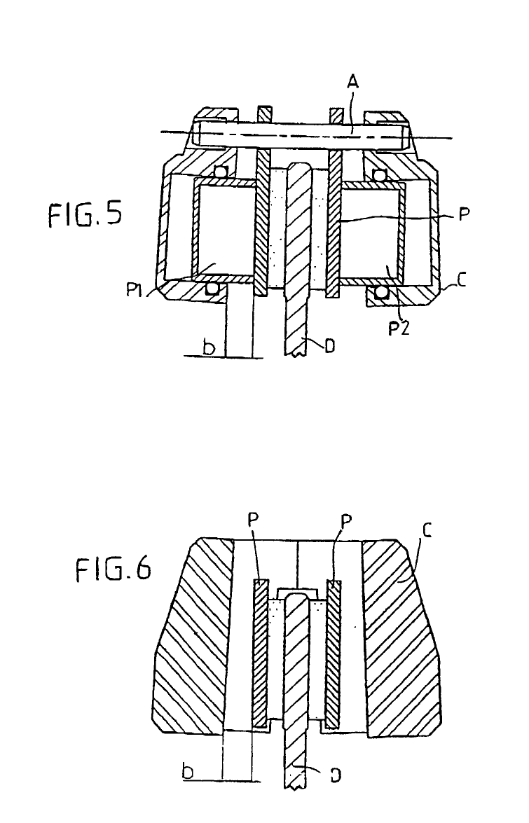

Reference is made to FIGS. 5 and 6 which show the influence of the deformation of the casing with respect to the pads. The distance (a) should be compared. The result of this is that, as the pressure rises, the friction between the pads and the casing detracts from the force of the pistons, which means that when the pressure drops, the friction is added to that of the pistons. This phenomenon gives rise to a hysteresis curve introducing an appreciable loss of faithfulness into the caliper.

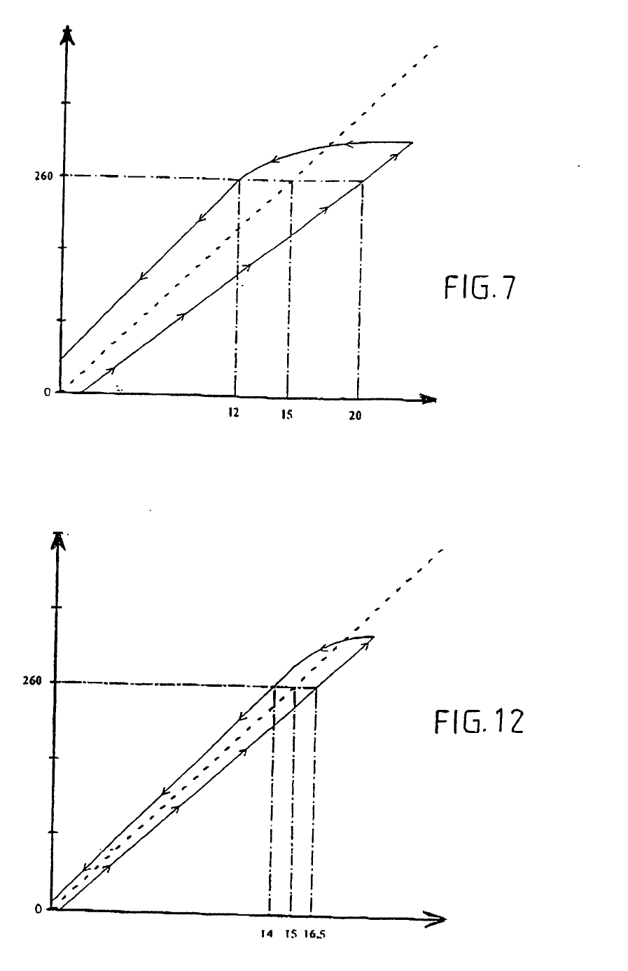

Reference is made to FIG. 7 which shows a hysteresis curve for a conventional brake caliper with opposed pistons. The tangential force measured is shown in solid line, while the theoretical tangential force is depicted in broken line. The x-axis shows the pressures in the circuit, the pressure being indicated in bar, while the y-axis shows the tangential forces on the disk in daN.

This prior art can be illustrated by the teaching of GB patent 998 612 in which the brake pads are fixed in a zone of the casing where there is deformation.

This hysteresis phenomenon resulting from the friction between the pad and the casing, under the pressure force exerted on the pistons, has the effect that the driver cannot test the deceleration precisely, and above all cannot appreciably reduce the tangential forces without significantly relaxing the pressure in order to reduce this force. These problems force racing drivers to pump the control actuating member (lever or pedal) in an attempt always to fall on the rising-pressure side of the curve so that the falling-pressure side of the curve is never used. This technique of pumping the brakes, which consists in exerting force on the brake lever or pedal and of immediately relaxing this force, successively and continuously, is not accessible to the ordinary driver who may be caught out by a deceleration which always differs for the same force applied to the brake lever or pedal.

It therefore proves to be difficult to get a feel for and to correctly meter the braking. This lack of control over the braking invariably leads to inappropriate decelerations which may have damaging consequences, including when the vehicle is equipped with an anti-lock braking system which, as mentioned, has a tendency to lengthen stopping distances.

As the problem is thus set out clearly, and in order to remedy the abovementioned disadvantages, it has seemed necessary to be able to eliminate or at the very least to reduce very appreciably the direct or indirect friction between the part of the casing which moves under the pressure and the pads.

To solve this problem, there has been designed and developed a brake caliper comprising at least two opposed pistons mounted in a casing exhibiting arrangements for mounting, in two parallel planes, two pads paired with said pistons to act on at least one disk. According to the invention, the arrangements for mounting the pads consist of means able to react the tangential force of said pads so as to prevent these from moving at the time of braking, said means being arranged in one or more zones of the casing where there is no deformation.

To solve the problem posed, the means consist of two pints mounted so that they are semi-free in the casing. The pins are mounted transversely in arrangements exhibited by the ends of the pads, at their upper part, said pads not being in contact with the casing.

Bearing these arrangements in mind, the result is that the pads move practically not at all with respect to the zone in which they are mounted in the casing of the caliper which opens under the pressure force. In other words, the deformation of the caliper casing does not generate friction of the pads which move practically not at all with respect to the mounting pins. The hysteresis is negligible given that the compressibility of the disk and of the friction material of the pads is negligible.

The invention is explained in greater detail hereinafter with the aid of the figures of the accompanying drawings in which:

FIG. 1 is a front view of schematic nature of a caliper according to the prior art;

FIG. 2 is a view from above corresponding to FIG. 1;

FIG. 3 is a view in cross section on A-A of FIG. 2, in the rest position;

FIG. 4 is a view in cross section on B-B of FIG. 2, in the rest position;

FIGS. 5 and 6 are views in cross section, corresponding respectively to FIGS. 3 and 4 and showing the opening the casing of the caliper under a pressure force;

FIG. 7 shows the hysteresis curve obtained in the case of a conventional brake caliper with opposed pistons;

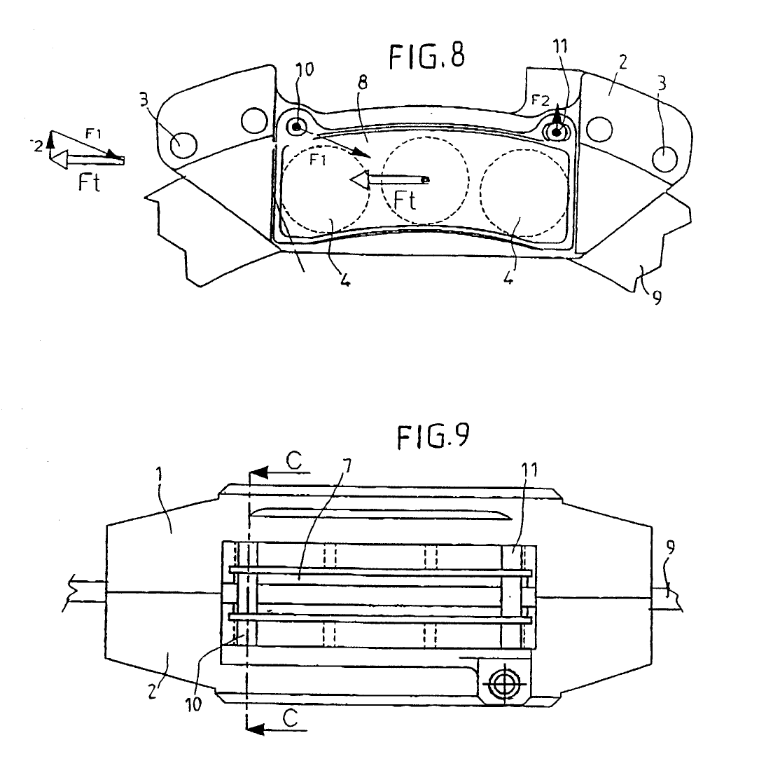

FIG. 8 is a view similar to FIG. 1 showing a caliper according to the characteristics of the invention;

FIG. 9 is a view from above corresponding to FIG. 8;

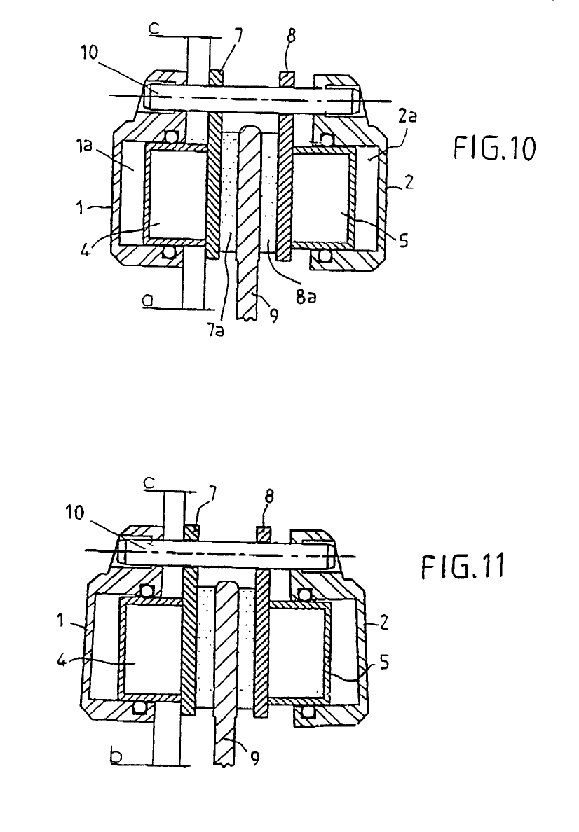

FIG. 10 is a view in cross section on C-C of FIG. 9, in the rest position;

FIG. 11 is a view corresponding to FIG. 10 showing the behavior of the pads under the pressure force;

FIG. 12 shows the hysteresis curve obtained in the case of a brake caliper according to the characteristics of the invention.

In the example illustrated, the casing of the caliper is made in two distinct parts (1) and (2) assembled by any known means, for example using transverse screws (3). Of course, without in any way departing from the scope of the invention, a one-piece design of the casing is not excluded. Each of the parts (1) and (2) of the casing has arrangements in the form of counterbores (1a) (2a) particularly for mounting, in a sealed manner, at least two opposed pistons (4) and (5). The caliper as a whole exhibits any kind of arrangement for connecting it to the hydraulic circuit of the master cylinder in particular. These arrangements are not described in detail because they are perfectly well known to those skilled in the art and can be embodied in numerous different ways.

Likewise, in a known way, the parts (1) and (2) of the casing exhibit, practically at their central part, a recessed zone for housing the brake pads (7) and (8), the brake linings (7a) and (8a) of which are arranged on each side of and facing each of the faces of a disk (9).

To solve the set problem of eliminating friction between the part of the casing which moves under the pressure and the pads, the tangential force (Ft) of the pads is reacted by two pins (10) and (11) mounted at each of the ends of said pads to be engaged and fixed with limited ability to move in arrangements of the parts (1) and (2) of the casing. For example, each of the ends of the pads (7) and (8) has, at its upper part, a protrusion to engage the fixing pins (10) and (11).

According to these features, it can be seen that the fixing pins (10) and (11), able to hold the pads in place, are arranged in arrangements of the casing which are situated near to a solid zone on said casing which does not have a tendency to deform under the pressure force. Reference is made to FIGS. 8, 9 and 10.

When the caliper is deformed under the pressure force resulting from braking, the pads (7) and (8) move practically not at all with respect to the two pins (10) and (11) (FIG. 11), given that these pins are arranged in a zone of the casing where there is no deformation. The tangential force of the pads is therefore reacted by the two pins. There is therefore no friction and therefore no hysteresis given that the compressibility of the disk and of the friction material of the pads is negligible. If FIGS. 10 and 11 are compared, it can be seen that the distance (C) between the rest position and the pressure position of the caliper remains constant.

As a result, the metering error is substantially reduced, as can be seen from FIG. 12 which shows the theoretical tangential force, depicted in broken line, as compared with the measured tangential force, depicted in solid line. Hysteresis is greatly reduced. In the same way as for FIG. 7 which relates to the hysteresis curve of a conventional brake caliper, the x-axis shows, in bar, the pressures in the circuit and the y-axis shows the tangential force on the disk, in daN.

The advantages are clearly apparent from the description. In particular, it is emphasized and reiterated that there is a possibility of correctly feeling and metering braking while surprisingly and unexpectedly seeing an improvement in the anti-lock braking system when the vehicle is equipped with one.

1. A brake caliper comprising at least two opposed pistons (4) and (5) mounted in a casing (1-2) exhibiting arrangements for mounting, in two parallel planes, two pads (7) and (8) paired with said pistons to act on at least one disk (9), characterized in that:
the arrangements for mounting the pads (7) and (8) consist of means (10) and (11) able to react the tangential force of said pads so as to prevent these from moving at the time of braking;
the means (10) and (11) able to react the tangential force of the pads (7) and (8) are arranged in one or more zones of the casing (1-2) where there is no deformation.

2. The brake caliper as claimed in claim 1, characterized in that the means consist of two pints (10) and (11) mounted so that they are semi-free in the casing (1-2).

3. The brake caliper as claimed in claim 1, characterized in that the pins (10) and (11) are mounted transversely in arrangements exhibited by the ends of the pads, at their upper part, said pads (7) and (8) not being in contact with the casing (1-2).
